(19) United States
(12) Patent Application Publication
(10) Pub. No.: US 2026/0072671 A1
(43) Pub. Date: Mar. 12, 2026

(54) SYSTEMS AND METHODS FOR CONTINUOUS INTEGRATION AND CONTINUOUS DEPLOYMENT

(71) Applicant: Capital One Services, LLC, McLean, VA (US)

(72) Inventors: Damandeep SINGH, Herndon, VA (US); David Kelly WURMFELD, Melbourne, FL (US); Regina WINGATE, Arlington, VA (US); Son MAYS, Ashburn, VA (US); Johan VANDEGRIFF, Alexandria, VA (US); Shane HOGAN, Brunswick, MD (US)

(73) Assignee: Capital One Services, LLC, McLean, VA (US)

(21) Appl. No.: 18/828,540

(22) Filed: Sep. 9, 2024

(51) Int. Cl. G06F 8/65; G06F 11/36

(52) U.S. Cl. CPC G06F 8/65; G06F 11/3688

(57) ABSTRACT

A remote computing system communicatively coupled to a plurality of hardware devices may receive a software update for software running on each of the hardware devices, where at least one of the hardware devices is a quality assurance (QA) device. The software update may be deployed to the QA device, and a robotic test system electrically and mechanically connected to the QA device may perform a test on one or more operational parameters of the QA device after the software update is applied to the software running on the QA device. A result of the test may be received, and a determination of whether the result meets a deployment threshold is made. When the result meets the deployment threshold, the software update may be deployed to at least a subset of the hardware devices. Otherwise, a deployment of the software update to any of the hardware devices is denied.

### TECHNICAL FIELD

Various embodiments of this disclosure relate generally to techniques for automated continuous integration and continuous delivery/deployment (CI/CD), and, more particularly, to systems and methods for integrating robotic testing of physical hardware devices into CI/CD pipelines.

### BACKGROUND

Automated CI/CD pipelines for end-to-end testing and deployment of software only components are conventionally implemented to confirm that the software will behave as expected prior to deployment. However, end-to-end testing of software configured to be run on physical hardware devices, such as interactive kiosks, is significantly more complex. For example, robotic testing on the hardware components is performed manually by a team of engineers, independent of software only component testing, to confirm that the physical hardware devices will behave or operate as expected when running the software prior to deployment of the software on the physical hardware devices.

This disclosure is directed to addressing the above-referenced challenges, among other challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to systems. An example system may include: a plurality of hardware devices each running software, where at least one of the plurality of hardware devices is a quality assurance device; a robotic test system communicatively and mechanically coupled to the quality assurance device and configured to test one or more operational parameters of the quality assurance device; and a remote computing system communicatively coupled to the plurality of hardware devices and configured to perform operations. The operations may include: receiving a software update to the software; deploying the software update to the quality assurance device, where the robotic test system performs a test on the one or more operational parameters of the quality assurance device after the software update is applied to the software running on the quality assurance device; receiving a result of the test; determining the result meets a deployment threshold; and based on the result meeting the deployment threshold, deploying the software update to at least a subset of the plurality of hardware devices.

In some aspects, the techniques described herein relate to computing systems. An example computing system may include at least one memory storing instructions, and at least one processor operatively connected to the at least one memory and configured to execute the instructions to perform operations. The operations may include: receiving a software update for software running on each of a plurality of hardware devices, where at least one of the plurality of hardware devices is a quality assurance device; deploying the software update to the quality assurance device, where a robotic test system electrically and mechanically connected to the quality assurance device performs a test on one or more operational parameters of the quality assurance device after the software update is applied to the software running on the quality assurance device; receiving a result of the test; determining the result meets a deployment threshold; and based on the result meeting the deployment threshold, deploying the software update to at least a subset of the plurality of hardware devices.

In some aspects, the techniques described herein relate to computer-implemented methods. An example computer-implemented method may include: receiving a software update for software running on each of a plurality of hardware devices, where at least one of the plurality of hardware devices is a quality assurance device; deploying the software update to the quality assurance device, where a robotic test system electrically and mechanically connected to the quality assurance device performs a test on one or more operational parameters of the quality assurance device after the software update is applied to the software running on the quality assurance device; receiving a result of the test; determining whether the result meets a deployment threshold; when the result meets the deployment threshold, deploying the software update to at least a subset of the plurality of hardware devices; and when the result fails to meet the deployment threshold, denying a deployment of the software update to any of the plurality of hardware devices.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which a fully automated CI/CD process integrating robotic testing of physical hardware devices can be implemented, according to certain embodiments.

FIG. 2 depicts a flowchart of an exemplary automated CI/CD process, according to certain embodiments.

FIG. 3 depicts a flowchart of a testing process, according to certain embodiments.

FIG. 4 depicts a flowchart of an exemplary software update deployment process, according to certain embodiments.

FIG. 5 depicts an exemplary robotic test system coupled to an exemplary quality assurance device, according to certain embodiments.

FIG. 6 depicts an example of a computer, according to certain embodiments.

### DETAILED DESCRIPTION OF EMBODIMENTS

According to certain aspects of the disclosure, methods and systems are disclosed for automated CI/CD, and, more particularly, to systems and methods for integrating robotic testing of physical hardware devices into CI/CD pipelines. For example, a CI/CD platform may control deployment of software to a plurality of hardware devices via a pipeline or workflow. To integrate robotic testing of the hardware devices into the pipeline, prior to deploying any update, patch, or other similar change to the software to the hardware devices in production, the update is deployed to a quality assurance hardware device that is communicatively and mechanically coupled to a robotic test system configured for testing operational parameter(s) of the quality assurance device. The update may then be deployed to a subset or all of the hardware devices in production in response to test results meeting a deployment threshold, among other pipeline verifications and approvals.

Reference to any particular activity is provided in this disclosure only for convenience and is not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Similarly, the term “or” is intended to mean “and/or,” unless explicitly stated otherwise. Relative terms, such as, “substantially” and “generally,” are used to indicate a possible variation of ±10% of a stated or understood value.

Terms like “physical device,” “hardware device, or “physical hardware device” generally encompass any type of physical device having hardware components configured for executing or running software on the physical device. An “operational behavior” of the hardware device may include any number of functions or tasks configured to be performed by the hardware device when the software is running, where performance levels associated with the functions or tasks may potentially be affected or impacted by updates, patches, or other similar changes to the software. A “quality assurance (QA) device” is a particular hardware device that is configured to be tested to observe the operational behavior thereof when any updates, patches, or other similar changes to the software are made. A QA device is a non-production device. A “robotic test system” generally encompasses any type of automated system configured to control one or more auxiliary components for interacting with the QA device to perform the testing.

In an exemplary use case, certain embodiments may be performed for integrating robotic testing into automated CI/CD pipelines to enable fully automated end-to-end testing and deployment across both software and hardware components of a system. For example, a CI/CD platform may control deployment of software to a plurality of hardware devices (e.g., a fleet of hardware devices) via an automated pipeline or workflow. One example fleet of hardware devices may include kiosks or other similar interactive devices configured to generate and print documents or dispense or receive other items responsive to user requests. Any time new code indicating an update, patch, or other similar change to the software is received, a software update is generated based on the new code. The new code may be cloud code to be executed by a remote computing system (e.g., a cloud-based system) interacting with the hardware devices. Alternatively, the new code may be machine code to be executed by the hardware devices.

To integrate the robotic testing into the automated pipeline, the software update is initially deployed to one of the hardware devices that is configured as a QA device communicatively and mechanically coupled to a robotic test system for testing operational parameter(s) of the QA device. The testing on the QA device may evaluate an impact of the software update on operational behavior across the hardware devices prior to deployment to those hardware devices (e.g., to proactively avoid deploying an update with negative impact to a large number of devices). The results of the testing may be provided for use as decisioning logic to the pipeline. For example, the software update may then be deployed to a subset or all of the hardware devices in response to results of the testing meeting a deployment threshold indicative of a non-negative impact on the operational behavior, among other pipeline verifications and approvals.

While specific examples included throughout the present disclosure involve hardware devices, such as kiosks, interacted with by users to generate and print documents, including financial documents or instruments, it should be understood that techniques according to this disclosure may be adapted to other types of hardware devices. For example, the techniques may be adapted to any fleet of hardware devices that run software thereon to ensure that any software update pushed or deployed to the fleet does not negatively impact operational behaviors of the hardware devices. It should also be understood that the examples above are illustrative only. The techniques and technologies of this disclosure may be adapted to any suitable activity.

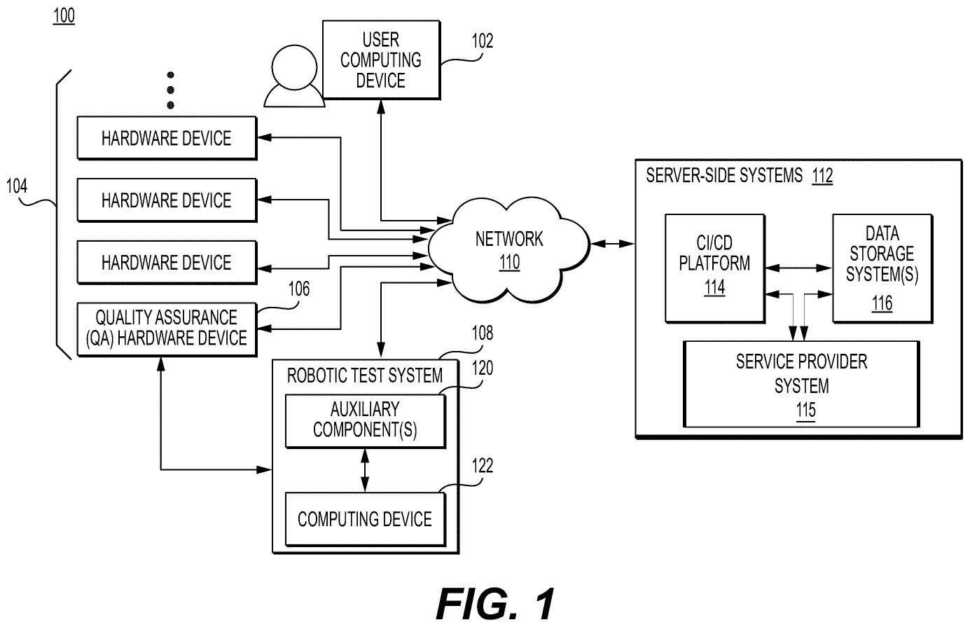

FIG. 1 depicts an exemplary environment 100 in which a fully automated CI/CD process integrating robotic testing of physical hardware devices can be implemented, according to certain embodiments. A user computing device 102, a plurality of hardware devices 104, or a robotic test system 108 may be computing devices that communicate with one or more of the other components of the environment 100 across electronic network 110, including one or more server-side systems 112.

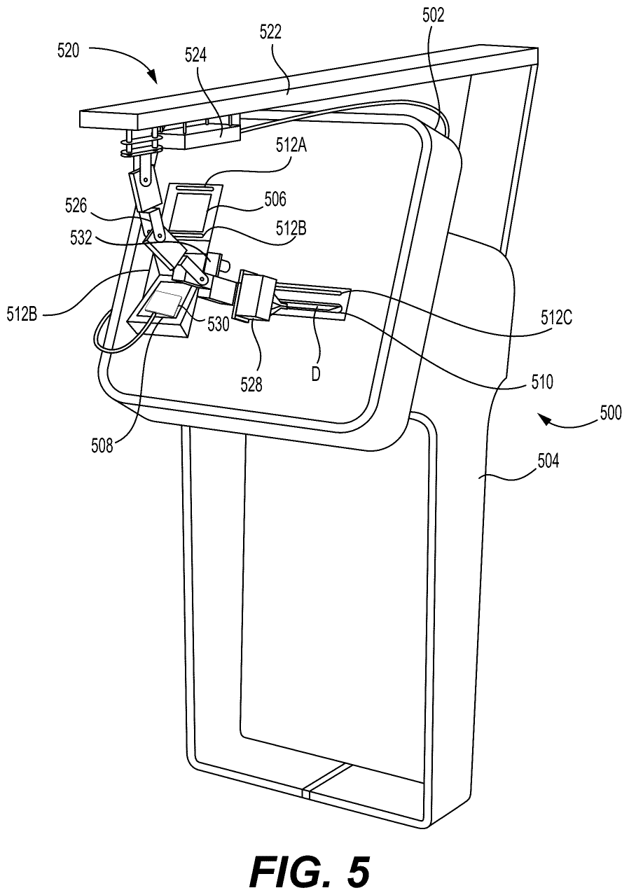

The user computing device 102 may be associated with a developer that generates code for software, including new code for updates, patches, or other similar changes to the software. The hardware devices 104 may be configured to receive, install, and execute the software and any subsequent software updates, patches, or other changes. Additionally, the hardware devices 104 may be interactive devices having at least a display configured to enable user interaction with the hardware devices 104 as the software is executing thereon. To provide one illustrative example, the hardware devices 104 may be kiosk devices configured to generate and print documents responsive to user requests. As described in greater detail with reference to FIG. 5, the kiosk devices may have a plurality of physical components, including the display, that are configured to perform specific functions based on execution of the software. The hardware devices 104 may be owned by a first entity. In some examples, the developer may be associated with the first entity (e.g., may be an employee of the first entity or provide third party software development services to the first entity).

At least one of the hardware devices 104 may be configured as a quality assurance (QA) hardware device, hereinafter QA device 106. Any changes or updates to software received from user computing device 102, for example, may initially only be deployed on QA device 106 for testing. Once deployed, the robotic test system 108 may be configured to test one or more operational parameters of QA device 106 (e.g., test if and how well the specific functions are being performed based on execution of the software with the update deployed). The robotic test system 108 may include one or more auxiliary component(s) 120 and a computing device 122. The computing device 122 may be communicatively coupled to the QA device 106 and configured to control the auxiliary component(s) 120 to perform the testing. The auxiliary component(s) 120 may be tailored to the specific functions performed by the hardware devices 104 as the software is executing thereon. Continuing with the above-provided illustrative example, and as described in more detail with reference to FIG. 5, example auxiliary component(s) 120 of the robotic test system 108 used in conjunction with the kiosk devices include an arm having an end effector to grab, adjust, or otherwise manipulate a document once printed, a code generation and display device to mimic user device interactions for initiating generation and printing of the document, and a camera to inspect the printed document. In some examples, the auxiliary component(s) 120 may also include a display.

The testing facilitated by the robotic test system 108 allows an impact of the software update on the operational behavior across the hardware devices 104 to be evaluated on QA device 106 (e.g., a representative of the hardware devices 104) prior to deploying the update to a subset or all of remaining hardware devices 104. The evaluation, quantitated by results of the test, can be incorporated as decisioning logic into a pipeline or workflow controlled by CI/CD platform 114 that is used, among other data, to determine whether to deploy the software update or otherwise deny a release thereof. Resultantly, deployment of software updates to the hardware devices 104 in production can be prevented when any potential negative impacts may be detected (e.g., if the update causes one or more functions to not operate properly or at all). While only one QA device 106 and one robotic test system 108 are depicted in FIG. 1, environment 100 may include more than one of each device and system, respectively.

The server-side systems 112 may include the CI/CD platform 114, a service provider system 115, or one or more data storage system(s) 116, among other systems. In some embodiments, the CI/CD platform 114, the service provider system 115, and the data storage system(s) 116 may be associated with a common entity. In such embodiments, the CI/CD platform 114, the service provider system 115, and the data storage system(s) 116 may be part of a cloud service computer system (e.g., in a data center). In some examples, the common entity may be the first entity owning the hardware devices 104. In other examples, the common entity may be a different, second entity. In other embodiments, the CI/CD platform 114, the service provider system 115, or the data storage system(s) 116 may be associated with a different entity than one another or the first entity owning the hardware devices 104. For example, the CI/CD platform 114 may be associated with a third party that provides automated deployment services to the first entity owning the hardware devices 104, the service provider system 115 may be associated with a same or different third party that provides hardware device services to the first entity, or the data storage system(s) 116 may be associated with a same or different third party that provides data storage services to the first entity. The systems and devices of the environment 100 may communicate in any arrangement. As will be discussed herein, systems or devices of the environment 100 may communicate in order to integrate robotic testing of the hardware devices 104 into an automated CI/CD process, among other activities.

The network 110 over which the one or more components of the environment 100 communicate may include one or more wired or wireless networks, such as a wide area network (“WAN”), a local area network (“LAN”), personal area network (“PAN”), a cellular network (e.g., a 3G network, a 4G network, a 5G network, etc.) or the like. In some embodiments, the network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. The user computing device 102, the hardware devices 104 including QA device 106, the robotic test system 108, and one or more of the server-side systems 112 may be connected via the network 110, using one or more standard communication protocols. The user computing device 102, the hardware devices 104 including QA device 106, the robotic test system 108, and one or more of the server-side systems 112 may transmit and receive communications from each other across the network 110, as discussed in more detail below.

The user computing device 102 may be configured to enable access to or interaction with other systems in the environment 100 to provide software code to be run on the service provider system 115 or the hardware devices 104 to perform various hardware devices services, including any new code for updates, patches, or other similar changes being made to the software. In some examples, the code may be provided directly to the CI/CD platform 114. In other examples, the code may be provided, via the service provider system 115, to CI/CD platform 114. Additionally, user computing device 102 may be configured to receive notifications from CI/CD platform 114 indicating results of tests performed on the QA device 106 to evaluate the impact of software updates or notifications from CI/CD platform 114 indicating successful deployments of the software updates on the hardware devices 104. The user computing device 102 may be a computer system such as, for example, a desktop computer, a laptop computer, a tablet, a smart cellular phone (e.g., a mobile phone), a smart watch or other electronic wearable, etc.

The hardware devices 104, including the QA device 106, may each have a computing device component (not shown) configured to enable access to or interaction with other systems in the environment 100, including at least the CI/CD platform 114, to receive and install software and any subsequent updates, patches, or other similar changes to the software thereon for execution in a production phase. The QA device 106 may be further configured to be placed in a testing phase when a new software update is received, and communicate with the computing device 122 of the robotic test system 108 to initiate a test of the operational parameters of the QA device 106 upon installation of the new software update on the QA device 106. The QA device 106 may provide results of the test to the CI/CD platform 114 for use as the decisioning logic within the pipeline. In other examples, the robotic test system 108 may directly communicate with the CI/CD platform 114, via the computing device 122, to receive instructions to initiate the test or provide the results of the test to the CI/CD platform 114.

In some examples, the hardware devices 104, including the QA device 106, may include an application deployment client, such as the ANSIBLE ® client or other similar client or tool, having a plurality of preset scripts that are mapped to a plurality of opcodes that the hardware devices 104 continuously poll or listen for to initiate the software testing or deployment. The opcodes may be set by the CI/CD platform in response to various stages or gates of the pipeline being reached, as discussed in more detail below.

In some embodiments, the user computing device 102, the computing device components of hardware devices 104 including QA device 106, and the computing device 122 of robotic test system 108 may include one or more electronic application(s), e.g., a program, plugin, browser extension, etc., installed on a memory of the respective devices. The electronic application(s) may include one or more of system control software, system monitoring software, software development tools, etc. In some embodiments, the electronic application(s) may be associated with one or more of the other components in the environment 100. For example, one or more of the electronic application(s) may include client applications associated with one or more of the server-side systems 112 (e.g., a client application of the CI/CD platform 114 or the service provider system 115). In some examples, one or more of the client applications may include thick client applications that are locally installed on the respective devices (e.g., desktop applications or mobile applications). In other examples, one or more of the client applications may include thin client applications (e.g., web applications) that are rendered via a web browser launched on the respective devices.

Additionally, the user computing device 102, the computing device components of hardware devices 104 including QA device 106, or the computing device 122 of robotic test system 108 may generate, or may cause to be generated, one or more graphic user interfaces (GUIs) based on instructions/information stored in the memory, instructions/information received from the other systems in the environment 100, or the like and may cause the GUIs to be displayed via a display of the respective devices. The GUIs may be, e.g., mobile application interfaces or browser user interfaces and may include text, input text boxes, selection controls, or the like. The display may include a touch screen or a display with other input systems (e.g., a mouse, keyboard, etc.) for the users of the respective devices to control the functions thereof.

The CI/CD platform 114 may include one or more server devices (or other similar computing devices) for executing CI/CD services. Example CI/CD services may include, but are not limited to, tasks associated with orchestrating, executing, or otherwise controlling a pipeline or workflow, such as a Jenkins pipeline, associated with software integration, delivery, and deployment, as described in detail below. An example pipeline may include a plurality of gates (e.g., approval gates or PR gates) that are configured to temporarily stop or halt the pipeline for various testing, checks, or approval. The number of gates may be adjustable or extendable. At each gate, various decisioning logic may be applied (e.g., based on testing results) to determine whether the software fails or moves onto the next gate within the pipeline, and eventually deploys into production.

The service provider system 115 may include one or more server devices (or other similar computing devices) for executing hardware device services. As one illustrative example, when the hardware devices 104 are configured to generate and print documents, the service provider system 115 may provide document generation and printing services. In such an example, and as described in more detail with reference to FIG. 5, the document generation and printing services may include tasks associated with facilitating interactions between the hardware devices 104 and user mobile devices to enable the request and fulfillment of documents for document types capable of being generated and printed by the hardware devices 104.

The data storage system(s) 116 may include a server system, computer-readable memory such as a hard drive, flash drive, disk, etc. In some embodiments, the data storage system(s) 116 include or interact with an application programming interface for exchanging data to other systems, e.g., one or more of the other components of the environment, such as at least the CI/CD platform 114. The data storage system(s) 116 may include a plurality of data stores. The data stores may include or act as a repository or source for various types of data. For example, the data may include code for the software and any software updates from the user computing device 102 or associated artifacts built based on the code. Also, the data may include deployment details received from the user computing device 102 associated with a particular subset of the hardware devices 104 to be deployed or a particular timing for deployment. Additionally, the data may include test results from the robotic test system 108 quantitating impacts of software updates on operational behavior of the QA device 106 for use as part of the deployment decisioning logic within the pipeline. Further, the data may include records for each of the hardware devices 104 indicating whether application of the software updates were successful or failed once deployed.

Although depicted as separate components in FIG. 1, it should be understood that a component or portion of a component in the system of exemplary environment 100 may, in some embodiments, be integrated with or incorporated into one or more other components. For example, one or more of data storage system(s) 116 may be integrated with the CI/CD platform 114 or the like. As another example, the QA device 106 and robotic test system 108 may be integrated within a single device or system. In some embodiments, operations or aspects of one or more of the components discussed above may be distributed amongst one or more other components. Any suitable arrangement or integration of the various systems and devices of the exemplary environment 100 may be used.

In the following disclosure, various acts may be described as performed or executed by a component from FIG. 1, such as the user computing device 102, the hardware devices 104 including the QA device 106, the robotic test system 108, or one or more of the server-side systems 112, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

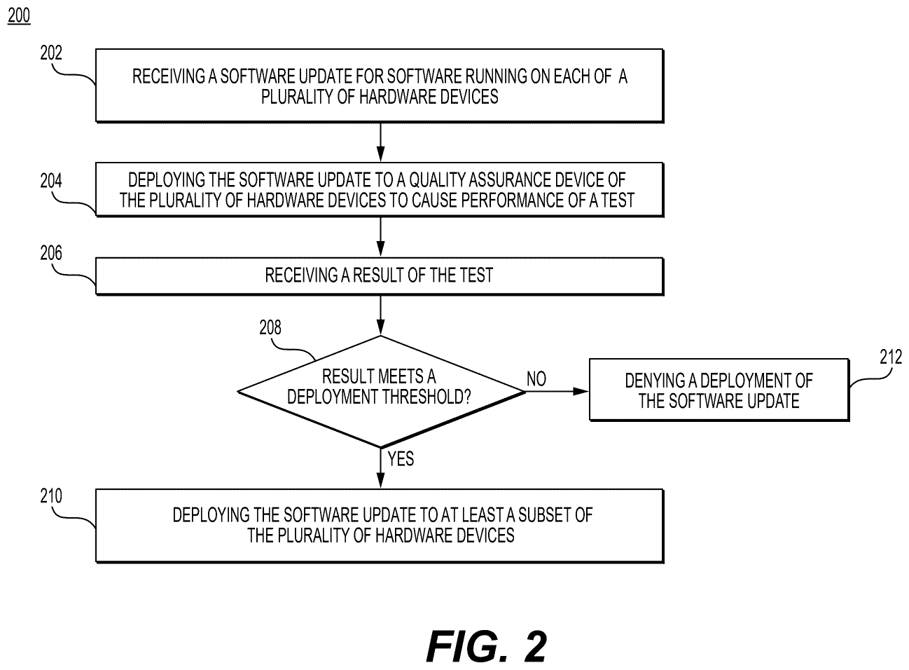

FIG. 2 depicts a flowchart of an exemplary automated CI/CD process, hereafter process 200, according to certain embodiments. In some examples, the process 200 may be performed by one or more of the server-side systems 112, such as the CI/CD platform 114.

At step 202, the process 200 may include receiving a software update for software running on each of a plurality of hardware devices, such as the hardware devices 104. For example, code for updates, patches, or other similar changes to the software may be received from the user computing device 102. The CI/CD platform 114 may build one or more artifacts for the software update based on the code. In some examples, a webhook call to a pipeline tool executed by the CI/CD platform 114 may initiate the artifact building as a first step, for example, of a pipeline or workflow being orchestrated, managed, or otherwise controlled by the CI/CD platform 114 via the pipeline tool. The code received may include cloud code to be executed by a remote computing system interacting with the hardware devices 104 (e.g., the service provider system 115). Additionally or alternatively, the code may include machine code to be executed by the hardware devices 104. Automatic end-to-end testing of software only components, as well as hardware components of the hardware devices 104, when the software update is deployed and run, may then be by performed via the pipeline.

For example, the pipeline may include a plurality of gates (e.g., approval gates or PR gates) that are configured to temporarily stop or halt the pipeline for various testing, checks, or approval. At each gate, the software update is either failed or moves onto the next gate within the pipeline. In some examples, an initial subset of one or more gates may be associated with testing performed on software only components (e.g., to test if software update behaves as expected when executed by the service provider system 115). Once a gate associated with hardware component testing is reached, the CI/CD platform 114 may cause one or more opcodes to be set that kick off or trigger the testing.

For example, at step 204, the process 200 may include deploying the software update to a quality assurance device of the plurality hardware devices, such as QA device 106 of the hardware devices 104, to cause performance of a test. For example, the QA device 106 may be continuously polling for any opcodes to be run. Once the opcodes are detected via the polling, the opcodes may be obtained and used to deploy the software update to the QA device 106. For example, application deployment client running on the QA device 106, may be configured to run one or more preset scripts that are mapped to the opcodes to apply the software update on the QA device 106 and cause testing, including robotic testing, to be performed on the QA device 106. The software update may be deployed to only the QA device 106 to allow for testing prior to deployment of the software update to any of the remaining of the hardware devices 104 (e.g., devices in production that are non-quality assurance devices) such that the results of the testing can be used as part of the deployment decisioning logic within the pipeline.

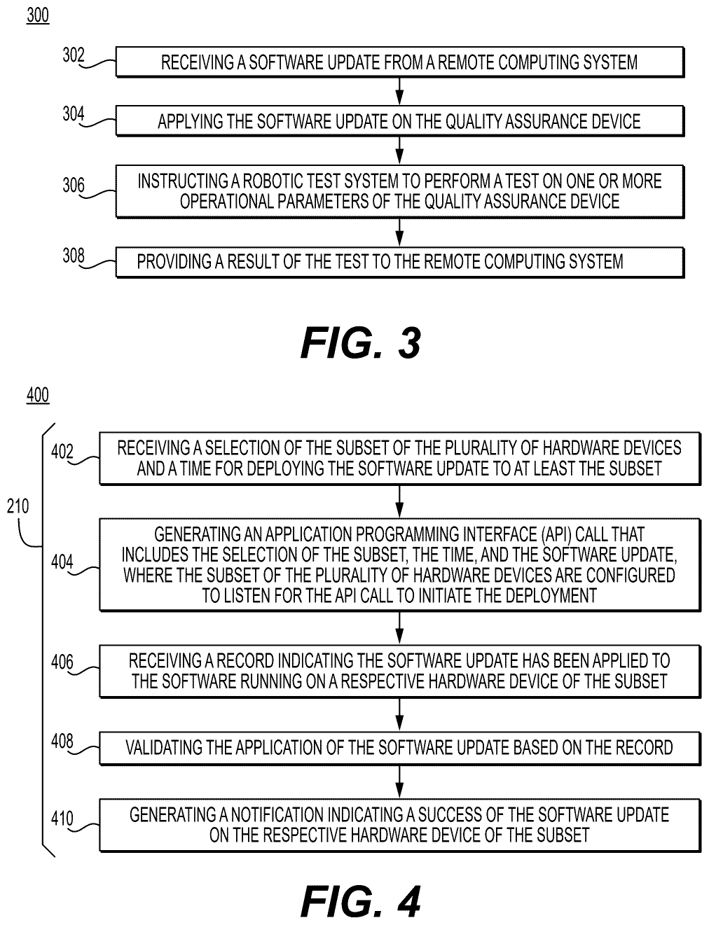

For example, turning to FIG. 3, FIG. 3 depicts a flowchart of a testing process, hereafter process 300, according to certain embodiments. In some examples, the process 300 may be performed by a quality assurance device of a plurality of hardware devices, such as the QA device 106 of the hardware devices 104.

At step 302, the process 300 may include receiving the software update from a remote computing system, such as the CI/CD platform 114. As described in detail above, the software update may be received in response to the QA device 106 polling for opcodes set by the CI/CD platform 114. At step 304, the process 300 may include applying the software update on the QA device 106. For example, the application deployment client of the QA device 106 may read the opcodes to enable mapped preset scripts to be run to apply the update. Resultantly, the software update may be installed on the QA device 106, and the QA device 106 may be placed in a testing state or phase.

At step 306, the process 300 may include instructing the robotic test system 108 to perform a test on one or more operational parameters of the QA device 106. For example, the test may be orchestrated by the QA device 106 and cause the robotic test system 108 to perform a sequence of actions or tasks as part of the test. Generally, the test may be performed on operational parameters that will enable an impact or effect of the software update on operational behavior across the hardware devices 104 to be gauged or evaluated, using the QA device 106 as a representative of the hardware devices 104. In other words, the operational parameters targeted for testing are parameter types that facilitate a determination as to whether the software update disrupts or otherwise alters functions configured to be performed by the hardware devices 104. In some examples, to identify or otherwise quantify the impact, performance levels associated with the functions may be collected as part of the test (e.g., to quantify if and how accurately the function was performed). To provide an illustrative example, and as described in more detail with reference to FIG. 5, when the hardware devices 104 are kiosks configured to generate and print documents, the operational parameters tested may include functions associated with user device interactions with the kiosks to initiate or validate a printing session, generating documents, printing documents, or dispensing documents.

At step 308, the process 300 may include providing a result of the test to the remote computing system (e.g., the CI/CD platform 114). In some examples, data collected by the robotic test system 108 as it is performing the sequence of actions may be provided to and analyzed by the QA device 106 to generate the result. The QA device 106 may then provide the result to the CI/CD platform 114. In other examples, the robotic test system 108 may generate the result based on the collected data for provision to the QA device 106 or the CI/CD platform 114. When the result is provided by the QA device 106 or the robotic test system 108, the result may be uploaded to a remote storage system accessible by the remote computing system, such as one of the data storage system(s) 116 accessible by the CI/CD platform 114, for storage in a data store therein.

Returning to FIG. 2, at step 206, the process 200 may include receiving the result of the test at the CI/CD platform 114. The result of the test may be received or accessed from the data store of the one of the data storage system(s) 116 after being uploaded to the data store by the QA device 106 or the robotic test system 108 as described with reference to FIG. 3. The result of the test may indicate an impact or effect of the software update on the operational behavior of the hardware devices 104, as represented by the QA device 106. The result of the test may be used as gate decisioning logic within the pipeline to determine whether the software update will be failed or moved on to a next gate within the pipeline. For example, at decision 208, the process 200 may include determining whether the result meets a deployment threshold. The deployment threshold may represent a level of operational behavior to be maintained in order to allow for deployment (e.g., at least 90% of expected functions are maintained at an appropriate performance level). The deployment threshold may be variable or adjustable.

When the result meets the deployment threshold at decision 208, the process may proceed to step 210. At step 210, the process 200 may include deploying the software update to at least a subset of the plurality of hardware devices 104, as described in more detail with reference to FIG. 4. In some examples, the software update may pass through one or more additional gates along the pipeline or workflow before being released for deployment into production. For example, a next gate may be associated with obtaining user approval prior to deployment. Otherwise, when the result does not meet the deployment threshold at decision 208, the process may proceed to step 212. At step 212, the process 200 may include denying a deployment of the software update.

In some examples, in either decisioning scenario, a notification may be generated and provided to the user computing device 102 to indicate the result of the test. Optionally, when the result of the test does not meet the deployment threshold, the notification may include additional information about the operational parameters of the QA device effected or impacted by the software update.

FIG. 4 depicts a flowchart of an exemplary software update deployment process, hereafter process 400, according to certain embodiments. In some examples, the process 400 may be performed by one or more of the server-side systems 112, such as the CI/CD platform 114. Process 400 may be performed as part of step 210 of process 200 described with reference to FIG. 2, where the software update is deployed to at least a subset of the plurality of hardware devices 104.

At step 402, the process 400 may include receiving a selection of the subset of the plurality of hardware devices 104 and a time for deploying the software update to at least the subset. As one example, the subset and the associated deployment time may be selected according to a location of the hardware devices 104. For example, a first subset of hardware devices 104 located in a first time zone may be deployed together at a first time, followed by a second subset of hardware devices 104 located in a second time zone at a second time, and so on (e.g., resulting in a software update rollout from east to west). In other examples, the subset and the associated deployment time may be selected for the purpose of A/B or split testing.

At step 404, the process 400 may include generating an application programming interface (API) call that includes the selection of the subset, the time, and the software update. In some examples, the selections are set as opcodes. Each of the hardware devices 104 in the subset are configured to listen for the API call to initiate the deployment. For example, upon detecting the API call, the hardware devices 104 in the subset may each be configured to receive and apply the software update at the time indicated by the API call. To apply, the software update may be installed such that the update is run as the software is executed on each of the hardware devices 104 in the subset.

At step 406, the process 400 may include, for each of the hardware devices 104 in the subset, receiving a record indicating the software update has been applied to the software running on the respective hardware device 104. The record may be stored in associated with the respective hardware device 104 in one of the data storage system(s) 116. At step 408, the process 400 may include validating the application of the software update based on the record. At step 410, the process 400 may include generating a notification indicating a success of the software update on the respective hardware device 104. For example, the notification may be generated and provided to the user computing device 102 over the network 110.

Accordingly, certain embodiments may be performed for implementing CI/CD with integrated robotics testing of physical hardware devices. The processes 200, 300, and 400 described above are provided merely as examples, and may include additional, fewer, different, or differently arranged steps than depicted in FIGS. 2, 3, or 4.

FIG. 5 depicts an exemplary robotic test system 520 coupled to an exemplary quality assurance (QA) kiosk 500, according to certain embodiments. The QA kiosk 500 is one example type of the QA device 106 of the hardware devices 104, described with reference to FIG. 1. Similarly, the robotic test system 520 may be one example type of the robotic test system 108, described with reference to FIG. 1.

The QA kiosk 500 may be one of a plurality of kiosks. The kiosks may be systems configured to generate and print documents. The QA kiosk 500 may be the same as the remaining kiosks, except for the coupling of the QA kiosk 500 to the robotic test system 520 to enable testing of the hardware components of the QA kiosk 500, as orchestrated by the QA kiosk 500. For example, and as shown in FIG. 5, the kiosks, including the QA kiosk 500, may each include an interaction component 502 attached or otherwise connected to a stand or base 504. The interaction component or the base 504 may interiorly house or otherwise contain a computing device component (not shown) and printer component (not shown) therein. The interaction component 502 may also exteriorly house or otherwise contain components with which a user, or the robotic test system 520 in the case of the QA kiosk 500, interacts. For example, the interaction component 502 may include a display 506, a scanning mechanism 508, and a dispenser slot 510. In some examples, the interaction component 502 may also include a first light 512A associated with the display 506, a second light 512B associated with the scanning mechanism 508, or a third light 512C associated with the dispenser slot 510 that are configured to guide interactions with the above-defined components of the kiosk.

The robotic test system 520 may include a support structure 522, a computing device 524, an arm 526 having an end effector 528, a code generation and display device 530, or a camera 532. The support structure 522 may be configured to mechanically couple or attach the robotic test system 520 to the base 504 of the QA kiosk 500. Additionally, one or more components of the robotic test system 520 may be mounted to the support structure 522. For example, the computing device 524 and the arm 526 may be mounted or otherwise attached to the support structure 522. In addition to a mechanical coupling of the robotic test system 520 to the QA kiosk 500, at least the computing device 524 may be communicatively or electrically coupled to the computing device component of the QA kiosk 500 via a wired or wireless connection. The computing device 524 may be an example of the computing device 122 described with reference to FIG. 1. The arm 526 having the end effector 528, the code generation and display device 530, or the camera 532 may be example types of the auxiliary component(s) 120 described with reference to FIG. 1. The computing device 524 may be communicatively coupled to, and configured to control operations of, the arm 526 having the end effector 528, the code generation and display device 530, and the camera 532, based on instructions received from the QA kiosk 500.

An illustrative example of the functions performed by the kiosks (e.g., an expected operational behavior) as software associated with document generation and printing is running on the kiosks in production is first provided below to provide context for the subsequently addressed testing performed on the QA kiosk 500 by the robotic test system 520. As a user walks up to a kiosk, the kiosk may present, on the display 506, a first machine-readable code received from a remote computing system configured to provide document generation and printing services (e.g., the service provider system 115 of FIG. 1). The user may position an associated mobile user device relative to the display 506 to capture the first code (e.g., via camera(s) on the mobile user device). Responsive to capturing the first code, the mobile user device may launch an application via which the user may request a document D to be generated and printed by the kiosk. In some examples, the user may be prompted to log into the application by entering their username and password to establish an account session or complete a multi-step authentication by entering additional personal or contact information. As one example, the document D to be generated and printed may be a financial document or instrument, the application may be associated with a financial institution of the user, and the account session may be associated with the user's account(s) with the financial institution. In some examples, the financial document or instrument may be a document, such as a cashier's check, a personal check, a traveler's check, or money order, promising or guaranteeing the payment of a specific amount of money to a given individual or entity (e.g., a recipient) by the financial institution issuing the document.

The user may then request generation of the document D by entering, into the application, details associated with the document D. Continuing with the example where the document D is a financial document or instrument, the user may enter the account from which to pull the funds, the amount, the payee, or a memo. A second machine-readable code may then be generated and provided by the service provider system 115 for display on a user interface of the application. The user may hold the user mobile device up to the scanning mechanism 508 on the kiosk such that the kiosk may capture the second code for provision to the service provider system 115. The service provider system 115 may to perform an authentication using the first code and the second code, and instruct the kiosk to generate, print, and dispense the document D from the dispenser slot 510 upon authentication. The user may retrieve the document D from the kiosk. In some examples, if the user does not retrieve the document D within a predetermined period of time, the document D may be retracted back into the kiosk using a retraction mechanism of the kiosk.

The robotic test system 520 is configured to mimic the user or user mobile device interactions with the kiosk when the operational parameters of the QA kiosk 500 are being tested. The operational parameters tested may include functions associated with interacting with user mobile devices to initiate or validate a printing session, generating documents, printing documents, or dispensing documents. For example, when the QA kiosk 500 detects and reads opcodes set by the CI/CD platform 114 when an appropriate gate in the pipeline is reached, preset scripts mapped to the opcodes are executed to obtain and apply the software update on the QA kiosk 500, as well as run a test suite to orchestrate the test once the software update is applied.

As part of the test orchestration, instructions may be provided from the QA kiosk 500 to the computing device 524. The instructions may cause the computing device 524 to initiate and control a sequence of actions or tasks to perform the test. For example, the code generation and display device 530 may be caused to generate and display a code corresponding to the second code described above. In some aspects, the service provider system 115 may include a listing of test documents that each include document details and are associated with an identifier to mimic document requests generated by users via the application. The second code may include the identifier. Based on the position of the code generation and display device 530 relative to the scanning mechanism 508, the scanning mechanism 508 may capture or read the second code for provision to the service provider system 115.

The service provider system 115 may then provide document data containing the document details for the document associated with the identifier included in the second code to the QA kiosk 500, which causes the QA kiosk 500 to generate or print the document D based on the document data, and dispense the document D through the dispenser slot D. The computing device 524 of the robotic test system 520 may control (e.g., move or otherwise position) the arm 526 to cause the end effector 528 to grab the document D dispensed from the dispenser slot 510.

In some examples, the end effector 528 may be adjusted such that the camera 532 is directed toward the document D to capture an image of the document D for analysis. The analysis may employ image recognition techniques to determine whether the document D was correctly generated or printed based on the document data. For example, a determination is made as to whether the document details are accurate as printed. In other examples, the document D may intentionally not be grabbed to instead test the operation of the retraction mechanism that is configured to retract the document D dispensed from the dispenser slot 510 back into the kiosk QA kiosk 500 after a predetermined period of time. In further examples, the network 110 may be disconnected temporarily to confirm the QA kiosk 500 continues to operate properly upon reconnection to the network 110.

As the various operational parameters of the QA kiosk 500 are being tested, data collected from the robotic test system 108 may be provided to the QA kiosk 500 for analysis to quantify the data. Once the testing is complete, the qualified data may be uploaded as a result by the QA kiosk 500 to one of the data storage system(s) 116 that is accessible by the CI/CD platform 114. In other examples, the computing device 524 of the robotic test system 108 may quantify the data or upload the quantified data as the result to the one of the data storage system(s) 116. The result may then be accessed by the CI/CD platform 114 for use as gate decisioning logic within the pipeline to determine whether to fail the software update or instead proceed to the next gate in the pipeline, and ultimately deploy the software update to the kiosks in production.

FIG. 5 describes orchestration of the test by the QA kiosk 500. However, in other examples, the test may be orchestrated by a separate computing device to which each of the QA kiosk 500 and robotic test system 520 are communicatively coupled to. In other words, the separate computing device may run the test suite.

In general, any process or operation discussed in this disclosure that is understood to be computer-implementable, such as the processes or operations depicted in FIGS. 2-5, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

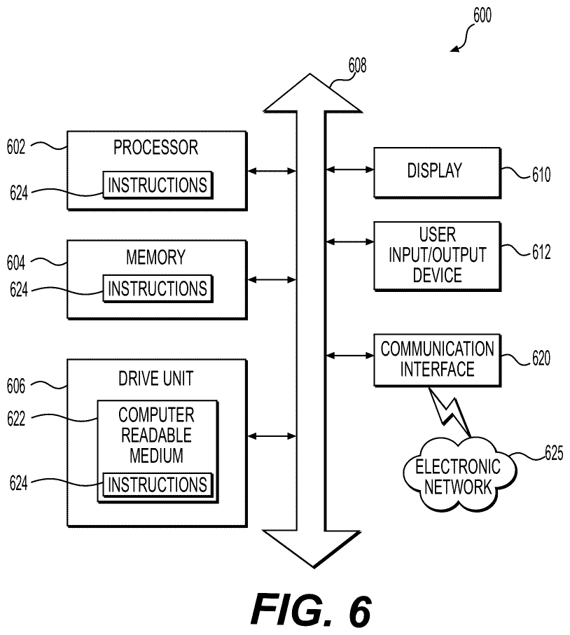

FIG. 6 depicts an example of a computer 600, according to certain embodiments. FIG. 6 is a simplified functional block diagram of a computer 600 that may be configured as a device for executing processes or operations depicted in, or described with respect to, FIGS. 2-5, according to exemplary embodiments of the present disclosure. For example, the computer 600 may be configured as one of the user computing device 102, the hardware devices 104 including the QA device 106, the computing device 122 of robotic test system 108, one of the server-side systems 112, or another device according to exemplary embodiments of this disclosure. In various embodiments, any of the systems herein may be a computer 600 including, e.g., a data communication interface 620 for packet data communication. The computer 600 may communicate with one or more other computers 600 using the electronic network 625. The electronic network 625 may include a wired or wireless network similar to the network 110 depicted in FIG. 1.

The computer 600 also may include a central processing unit (“CPU”), in the form of one or more processors 602, for executing program instructions 624. The program instructions 624 may include instructions for running one or more operations of the respective device or system. The computer 600 may include an internal communication bus 608, and a drive unit 606 (such as read-only memory (ROM), hard disk drive (HDD), solid-state disk drive (SDD), etc.) that may store data on a computer readable medium 622, although the computer 600 may receive programming and data via network communications. The computer 600 may also have a memory 604 (such as random access memory (RAM)) storing instructions 624 for executing techniques presented herein, although the instructions 624 may be stored temporarily or permanently within other modules of computer 600 (e.g., processor 602 or computer readable medium 622). The computer 600 also may include user input and output ports 612 or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A system comprising:
a plurality of hardware devices each running software, wherein at least one of the plurality of hardware devices is a quality assurance device;
a robotic test system communicatively and mechanically coupled to the quality assurance device and configured to test one or more operational parameters of the quality assurance device; and
a remote computing system communicatively coupled to the plurality of hardware devices and configured to perform operations, the operations including:
receiving a software update to the software;
deploying the software update to the quality assurance device, wherein the robotic test system performs a test on the one or more operational parameters of the quality assurance device after the software update is applied to the software running on the quality assurance device;
receiving a result of the test;
determining the result meets a deployment threshold; and
based on the result meeting the deployment threshold, deploying the software update to at least a subset of the plurality of hardware devices.

2. The system of claim 1, the operations further including:
receiving a selection of the subset of the plurality of hardware devices and a time for deploying the software update to at least the subset.

3. The system of claim 2, wherein deploying the software update to at least the subset includes:
generating an application programming interface (API) call that includes the selection of the subset, the time, and the software update, wherein the subset of the plurality of hardware devices are configured to listen for the API call to initiate the deployment.

4. The system of claim 1, wherein, for each hardware device of the subset, the operations further include:
receiving a record indicating the software update has been applied to the software running on the respective hardware device;
validating the application of the software update based on the record; and
generating a notification indicating a success of the software update on the respective hardware device.

5. The system of claim 1, wherein the test on the one or more operational parameters of the quality assurance device is performed to evaluate an impact of the software update on operational behavior across the plurality of hardware devices.

6. The system of claim 1, wherein the plurality of hardware devices are configured to generate and print documents, and the one or more operational parameters tested are functions associated with one or more of: interacting with user devices to initiate or validate a printing session, generating documents, printing documents, or dispensing documents.

7. The system of claim 1, wherein the robotic test system comprises:
one or more auxiliary components; and
a computing device communicatively coupled to and configured to control an operation of the one or more auxiliary components to perform the test, wherein the computing device is further communicatively coupled to the quality assurance device.

8. The system of claim 7, wherein the one or more auxiliary components include:
an arm having an end effector;
a code generation and display device; and
a camera.

9. The system of claim 7, wherein after the software update is applied to the software running on the quality assurance device, the quality assurance device provides instructions to the computing device of robotic test system to cause the robotic test system to perform the test.

10. The system of claim 7, wherein the computing device of robotic test system provides the result of the test to the quality assurance device, and wherein the quality assurance device uploads the result to a remote storage system accessible by the remote computing system.

11. The system of claim 1, wherein receiving the software update includes:
receiving new code associated with the software; and
building an artifact for the software update based on the new code.

12. A computing system comprising:
at least one memory storing instructions; and
at least one processor operatively connected to the at least one memory and configured to execute the instructions to perform operations, including:
receiving a software update for software running on each of a plurality of hardware devices, wherein at least one of the plurality of hardware devices is a quality assurance device;
deploying the software update to the quality assurance device, wherein a robotic test system electrically and mechanically connected to the quality assurance device performs a test on one or more operational parameters of the quality assurance device after the software update is applied to the software running on the quality assurance device;
receiving a result of the test;
determining the result meets a deployment threshold; and
based on the result meeting the deployment threshold, deploying the software update to at least a subset of the plurality of hardware devices.

13. The computing system of claim 12, the operations further including:
receiving a selection of the subset of the plurality of hardware devices and a time for deploying the software update to at least the subset.

14. The computing system of claim 13, wherein deploying the software update to at least the subset includes:
generating an application programming interface (API) call that includes the selection of the subset, the time, and the software update, wherein the subset of the plurality of hardware devices are configured to listen for the API call to initiate the deployment.

15. The computing system of claim 12, wherein, for each hardware device of the subset, the operations further include:
receiving a record indicating the software update has been applied to the software running on the respective hardware device;
validating the application of the software update based on the record; and
generating a notification indicating a success of the software update on the respective hardware device.

16. The computing system of claim 12, wherein the test on the one or more operational parameters of the quality assurance device is performed to evaluate an impact of the software update on operational behavior across the plurality of hardware devices.

17. The computing system of claim 12, wherein the plurality of hardware devices are configured to generate and print documents, and the one or more operational parameters tested are functions associated with one or more of: user device interactions with the plurality of hardware devices to initiate or validate a printing session, generating documents, printing documents, or dispensing documents.

18. The computing system of claim 12, wherein the quality assurance device receives and uploads the result of the test from the robotic test system to a remote storage system accessible by computing system, and receiving the result of the test includes:
obtaining the result of the test from the remote storage system.

19. The computing system of claim 12, wherein receiving the software update includes:
receiving new code associated with the software; and
building an artifact for the software update based on the new code.

20. A computer-implemented method comprising:
receiving a software update for software running on each of a plurality of hardware devices, wherein at least one of the plurality of hardware devices is a quality assurance device;
deploying the software update to the quality assurance device, wherein a robotic test system electrically and mechanically connected to the quality assurance device performs a test on one or more operational parameters of the quality assurance device after the software update is applied to the software running on the quality assurance device;
receiving a result of the test;
determining whether the result meets a deployment threshold;
when the result meets the deployment threshold, deploying the software update to at least a subset of the plurality of hardware devices; and
when the result fails to meet the deployment threshold, denying a deployment of the software update to any of the plurality of hardware devices.
